(19) United States
(12) Patent Application Publication
(10) Pub. No.: US 2026/0093895 A1
(43) Pub. Date: Apr. 2, 2026

(54) METHOD, APPARATUS, DEVICE, AND STORAGE MEDIUM FOR CONFIGURING KNOWLEDGE INFORMATION

(71) Applicant: Beijing Zitiao Network Technology Co., Ltd., Beijing (CN)

(72) Inventor: Yuanxi Zhang, Beijing (CN)

(21) Appl. No.: 18/987,674

(22) Filed: Dec. 19, 2024

(30) Foreign Application Priority Data
Sep. 29, 2024 (CN) 202411379543.9

(51) Int. Cl. G06F 40/106; G06F 40/166

(52) U.S. Cl. CPC G06F 40/106; G06F 40/166

(57) ABSTRACT

The disclosure relates to methods, apparatuses, devices and storage media for configuring knowledge information. An example method includes: presenting a configuration interface associated with target content, the target content added as knowledge information of a target application; presenting, in the configuration interface, initial hierarchical information determined by processing the target content, the initial hierarchical information indicating hierarchies corresponding to a plurality of content portions in the target content; determining target hierarchical information of the target content via the configuration interface, the target hierarchical information including the initial hierarchical information or updated hierarchical information determined by editing the initial hierarchical information; and organizing the target content into a plurality of knowledge segments based on the target hierarchical information, such that the target application processes a received request based on the plurality of knowledge segments.

### CROSS-REFERENCE

This application claims the priority to Chinese Patent Application No. 202411379543.9, filed on Sep. 29, 2024, entitled “Method, Apparatus, Device and Storage Medium for Configuring Knowledge Information”, the entire contents of which are incorporated herein by reference.

### FIELD

Example embodiments of the present disclosure generally relate to the field of computers, and in particular, to a method, an apparatus, a device, and a computer-readable storage media for configuring knowledge information.

### BACKGROUND

With the development of computer technologies, generative models are gradually applied to various aspects of people's lives. Some platforms also support users to configure various types of applications based on generative models, for example, agents or bots. The user may also configure corresponding knowledge information for such an application to support the application to process the corresponding request with reference to such knowledge information.

### SUMMARY

In a first aspect of the present disclosure, a method for configuring knowledge information is provided. The method includes the following steps: presenting a configuration interface associated with target content, the target content added as knowledge information of a target application; presenting initial hierarchical information determined by processing the target content in the configuration interface, the initial hierarchical information indicating hierarchies corresponding to a plurality of content portions in the target content; determining target hierarchical information of the target content via the configuration interface, the target hierarchical information including the initial hierarchical information or updated hierarchical information determined by editing the initial hierarchical information; and organizing the target content into a plurality of knowledge segments based on the target hierarchical information, such that the target application processes a received request based on the plurality of knowledge segments.

In a second aspect of the present disclosure, a method for creating an application is provided. The method includes the following steps: configuring knowledge information associated with a target application, wherein the knowledge information indicates a plurality of knowledge segments organized based on target content, wherein the plurality of knowledge segments are determined based on the following process: presenting initial hierarchical information determined by processing the target content in a configuration interface, the initial hierarchical information indicating hierarchies corresponding to a plurality of content portions in the target content; determining target hierarchical information of the target content via the configuration interface, the target hierarchical information including the initial hierarchical information or updated hierarchical information determined by editing the initial hierarchical information; and organizing the target content into a plurality of knowledge segments based on the target hierarchical information; and creating the target application based on the knowledge information.

In a third aspect of the present disclosure, an apparatus for configuring knowledge information is provided. The apparatus includes: an interface presenting module configured to present a configuration interface associated with the target content, the target content added as knowledge information of a target application; an information presenting module configured to present initial hierarchical information determined by processing the target content in the configuration interface, the initial hierarchical information indicating hierarchies corresponding to a plurality of content portions in the target content; a level determining module configured to determine target hierarchical information of the target content via the configuration interface, the target hierarchical information including the initial hierarchical information or updated hierarchical information determined by editing the initial hierarchical information; and a knowledge organizing module configured to organize the target content into a plurality of knowledge segments based on the target hierarchical information, such that the target application processes a received request based on the plurality of knowledge segments.

In a fourth aspect of the present disclosure, an apparatus for creating an application is provided. The apparatus includes: a knowledge configuration module configured to configure knowledge information associated with a target application, wherein the knowledge information indicates a plurality of knowledge segments organized based on target content, wherein the plurality of knowledge segments are determined based on the following process: presenting initial hierarchical information determined by processing the target content in a configuration interface, the initial hierarchical information indicating hierarchies corresponding to a plurality of content portions in the target content; determining target hierarchical information of the target content via the configuration interface, the target hierarchical information including the initial hierarchical information or updated hierarchical information determined by editing the initial hierarchical information; and organizing the target content into the plurality of knowledge segments based on the target hierarchical information; and an application creation module configured to create the target application based on the knowledge information.

In a fifth aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the device to perform the method of the first aspect or the second aspect.

In a sixth aspect of the present disclosure, a computer-readable storage medium is provided. The computer-readable storage medium stores a computer program thereon, and the computer program is executable by the processor to implement the method according to the first aspect or the second aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments according to the present disclosure may be implemented;

FIGS. 2A to 2D illustrate example interfaces according to some embodiments of the present disclosure;

FIG. 3 illustrates a flowchart of an example process for configuring knowledge information according to some embodiments of the present disclosure;

FIG. 4 illustrates a schematic structural block diagram of an example apparatus for configuring knowledge information according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are described for illustrative purposes only and are not intended to limit the scope of the present disclosure.

It should be noted that the title of any section/subsection provided herein is not limiting. Various embodiments are described throughout the description and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood as non-exclusive inclusion. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, collection, acquisition, processing forwarding, usage, etc. of all data are performed on the premise that the user knows and confirms. Accordingly, when implementing the embodiments of the present disclosure, the types of the data or information that may be involved, the user shall be informed of the type, application scope, and application scenario of the personal information involved in this disclosure in an appropriate manner and the user's authorization shall be obtained, in accordance with relevant laws and regulations. The specific notification and/or authorization manner may vary according to actual situations and application scenarios, and the scope of the present disclosure is not limited in this respect.

According to the solutions in the present specification and the embodiments, if personal information processing is involved, processing may be performed on the premise of having a legality basis (for example, obtaining consent of a personal information subject, or necessary for fulfilling contract), and the processing may be performed only within a specified or agreed range. The user rejects personal information other than necessary information required by the basic function, and does not affect the basic function of the user.

The generative model has the ability to reference to the configured knowledge information to process the request. For example, the generative model can process the corresponding request by searching for relevant knowledge segments (also referred to as slices). However, due to the limitation of the input size of the generative model, the organization way of the knowledge information will directly affect the quality of the model generation result.

The embodiment of the present disclosure provides a solution for configuring knowledge information. The solution comprises the following steps: presenting a configuration interface associated with target content, the target content added as knowledge information of a target application; presenting initial hierarchical information determined by processing the target content in the configuration interface, the initial hierarchical information indicating hierarchies corresponding to a plurality of content portions in the target content; determining target hierarchical information of the target content via the configuration interface, the target hierarchical information including the initial hierarchical information or updated hierarchical information determined by editing the initial hierarchical information; and organizing the target content into a plurality of knowledge segments based on the target hierarchical information, such that the target application processes a received request based on the plurality of knowledge segments.

In this way, the embodiments of the present disclosure can organize the knowledge segments corresponding to the content based on the hierarchical structure of the content, thereby improving the utilization efficiency of the knowledge information.

Various example implementations of this solution are described in detail below in conjunction with the accompanying drawings.

### EXAMPLE ENVIRONMENT

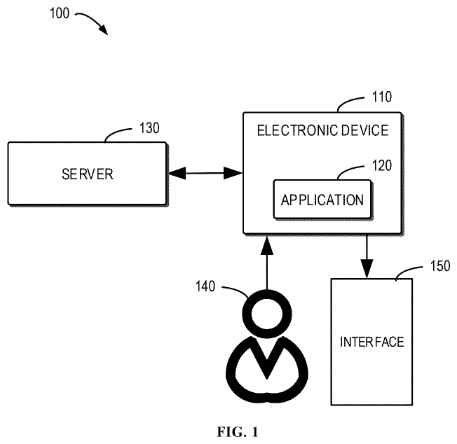

FIG. 1 illustrates a schematic diagram of an example environment 100 in which embodiments of the present disclosure can be implemented. As shown in FIG. 1, the example environment 100 may include an electronic device 110.

In this example environment 100, an application 120 that supports interface interaction may run on the electronic device 110. The application 120 may be any suitable type of application for interface interaction, examples of which may include, but are not limited to, development applications or other suitable applications. The user 140 may interact with the application 120 via the electronic device 110 and/or its attachment device.

In the environment 100 of FIG. 1, if the application 120 is active, the electronic device 110 may present, via the application 120, an interface 150 for supporting configuration of knowledge information.

In some embodiments, the electronic device 110 communicates with a server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable”circuit, etc.).

The server 130 may be a standalone physical server, a server cluster or a distributed system composed of multiple physical servers, or may be a cloud server that provides basic cloud computing services such as cloud services, cloud databases, cloud computing, cloud functions, cloud storage, network services, cloud communication, middleware service, domain name service, security service, content distribution networks, and big data and artificial intelligence platforms. The server 130 may include, for example, a computing system/server, such as a mainframe, an edge computing node, a computing device in a cloud environment, or the like. The server 130 may provide background services for the application 120 that supports virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for illustrative purposes only and do not imply any limitation to the scope of the present disclosure.

Some example embodiments of the present disclosure will be described below with continued reference to the accompanying drawings.

### EXAMPLE INTERACTION

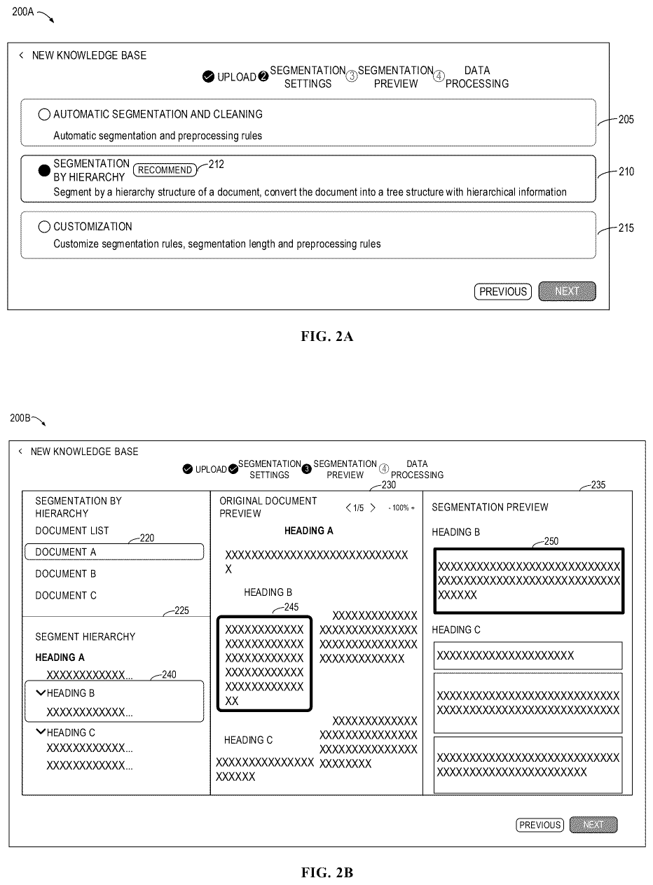

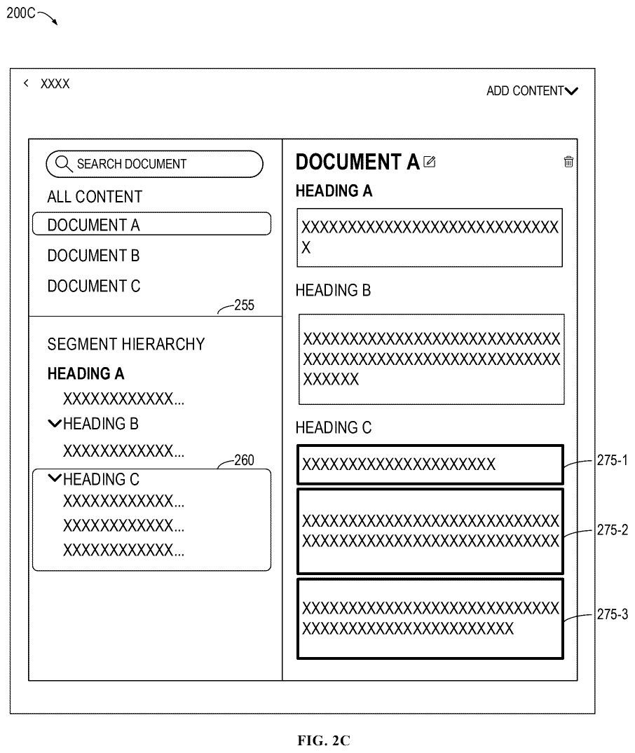

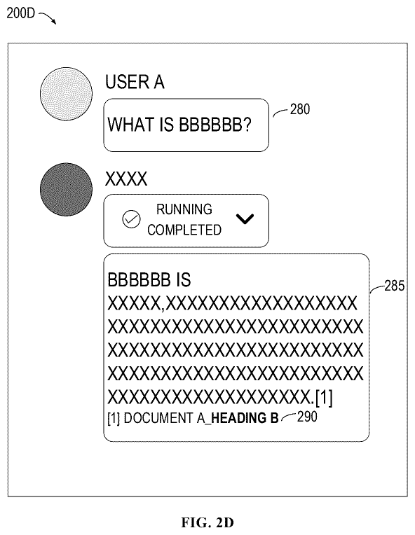

Example interactions for configuring knowledge information according to some embodiments of the present disclosure are described below in connection with FIGS. 2A to 2C. FIGS. 2A to 2C illustrate example interfaces 200A to 200C in accordance with some embodiments of the present disclosure. The interfaces 200A to 200C may be provided, for example, by the electronic device 110 shown in FIG. 1.

In some embodiments, the target application may be an agent constructed based on the generative model, bot, or other application suitable for calling a knowledge base, such as a digital assistant.

As an example, the electronic device 110 may support the user adding appropriate content to the knowledge base of the target application to serve as knowledge information accessible by the target application. As an example, the electronic device 110 may support the user uploading a local file as the target content. Such files may include, for example, appropriate formats such as documents, pictures, and the like.

Alternatively, the electronic device 110 may further support the user inputting a corresponding network address, to support adding the content corresponding to the network address to the knowledge base. For example, such content may include online documents, web pages, and the like.

As shown in FIG. 2A, the interface 200A may be a knowledge base configuration interface of the target application. As an example, after the user uploads a local file (for example, one or more documents) to the knowledge base of the target application, the electronic device 110 may present the interface 200A shown in FIG. 2A.

In the interface 200A, the electronic device 110 may provide a plurality of options 205, 210, and 215. The option 205, the option 210, and the option 215 may correspond to different knowledge information organization manners. As an example, the option 205 may indicate that the knowledge segments are organized based on paragraphs of the target content; the option 210 may indicate that the knowledge segments are organized based on a hierarchical structure of the target content; the option 215 may support the user customizing a specific logic for organizing the knowledge segments.

In some embodiments, the electronic device 110 may also present prompt information associated with the plurality of options 205, 210, and 215 to indicate a mode matching the target content to be configured. As an example, when determining that the target content to be configured satisfies a preset condition corresponding to the option 210, the electronic device 110 may present the recommendation element 212 in association with the option 210.

In some embodiments, the electronic device 110 may perform a pre-recognition of the hierarchical structure on the target content to determine whether the recognized hierarchical structure satisfies a preset condition. For example, such a preset condition may indicate whether the number of hierarchical nodes included in the hierarchical structure is greater than a preset number, whether a hierarchical depth of the hierarchical structure is greater than a preset depth, or the like. Alternatively, such preset condition may also indicate whether a confidence of the hierarchical recognition result generated by a hierarchical structure recognition model is greater than a threshold.

As an example, in the case that the option 210 is selected, the electronic device 110 may further display a configuration interface 200B as shown in FIG. 2B. The configuration interface 200B may display a list of content to be configured, e.g., “Document A,”“Document B,”and “Document C”.

Example interactions of the configuration knowledge information will be described below by taking the target content 220 (i.e., document A) as an example. As an example, the electronic device 110 may display initial hierarchical information 225 of the target content 220 in the configuration interface 200B.

In some embodiments, the initial hierarchical information 225 is determined by processing the target content 220, which indicates a content structure of the target content 220. Taking the target content 220 including an editable document as an example, the initial hierarchical information 225 may be determined based on a directory structure of the document.

In some embodiments, the initial hierarchical information 225 may also be determined by recognizing a hierarchical relationship between different segments in the target content 220. Taking a file in which the target content 220 includes a portable document format (PDF) as an example, a hierarchical relationship between different content segments in the file may be determined by recognizing a position relationship between different content segments. For example, the electronic device 110 may determine that a piece of content in the file is below a “Heading A”and may associate it with the hierarchy “Heading A”.

It should be understood that, depending on the specific form of the target content, embodiments of the present disclosure may extract the hierarchical structure of the content in any suitable manner as the initial hierarchical information.

Taking FIG. 2B as an example, the initial hierarchical information 225 may indicate that hierarchy “Heading A” is the parent Hierarchy of hierarchies “Heading B”and “Heading C”.

In some embodiments, the electronic device 110 may further obtain first configuration information, where the first configuration information indicates a maximum number of hierarchies allowed to be segmented. As an example, the electronic device 110 may determine the maximum number of hierarchies allowed to be segmented via a configuration control associated with the option 210 as shown in FIG. 2A.

Further, the electronic device 110 or the server 130 may segment the target content 220 based on the first configuration information to determine the initial hierarchical information 225. For example, the user may indicate that the maximum number of hierarchies allowed to be segmented is 2, then the content portions corresponding to “Heading B” and “Heading C” will not be further segmented into hierarchies of finer granularity.

Further, as shown in FIG. 2B, the configuration interface 200B may further include a first region 230. The first region 230 may display a preview result of the target content 220. As an example, the electronic device 110 may render an image of the target content 220 in the first region 230.

Additionally, as shown in FIG. 2B, the configuration interface 200B may further include a second region 235. The second region 235 may recognize a text recognition result of the target content 220. Taking a file in which the target content 220 includes a portable document format (PDF) as an example, the electronic device 110 or the server 130 may utilize OCR to recognize text content contained in the file. Accordingly, the electronic device 110 may display the recognized text content in the second region 235.

In some embodiments, the electronic device 110 may also receive a user selection of a target hierarchy 240 (e.g., Heading B) in the initial hierarchical information 225. Correspondingly, the electronic device 110 may display, in the first area 230, the content portion 245 corresponding to the target hierarchy 230; alternatively, or additionally, the electronic device 110 may further display, in the second area 235, a content portion corresponding to the target hierarchy, that is, the text recognition result 250. In this way, the user can intuitively perceive the original content and the recognition content corresponding to each level.

In some embodiments, the electronic device 110 may receive confirmation on the initial hierarchical information 225 by the user to use the initial hierarchical information 225 as the final hierarchical information of the target content 220 (i.e., the target hierarchical information).

Additionally, the electronic device 110 may also receive at least one edit operation on the initial hierarchical information 225 via the configuration interface 200B to determine updated hierarchical information. Further, the electronic device 110 may determine the edited updated hierarchical information as the final hierarchical information of the target content 220 (i.e., the target hierarchical information).

In some embodiments, the electronic device 110 may receive a first edit operation from the user and adjust a hierarchy associated with the at least one content portion. As an example, if the user determines that a paragraph should belong to “Heading B” instead of “Heading C”, the user may, for example, drag the paragraph from a position below the “Heading C” of the initial hierarchical information 225 to a position below the “Heading B”. Accordingly, the paragraph may be associated to the updated hierarchy (i.e., Heading B).

Alternatively, or additionally, the electronic device 110 may also receive a second edit operation from the user, and delete at least one hierarchy in the initial hierarchical information 225. As an example, the electronic device 110 may perform a preset operation (e.g., right click) on the hierarchy “Heading C” in the initial hierarchical information 225, such that a deletion control for deleting the hierarchy may be displayed. Further, the electronic device 110 may receive a selection of the deletion control, and may disassociate a content portion of a hierarchy from the hierarchy, and associate the hierarchy to another hierarchy. For example, in a case that a hierarchy of the “Heading C” is deleted, one or more paragraphs previously associated with the “Heading C” may be automatically associated to the “Heading B”.

Alternatively, or additionally, the electronic device 110 may also receive a third edit operation from the user to merge a plurality of hierarchies into the same hierarchy. As an example, the electronic device 110 may receive a user selection of “Heading B” and “Heading C” and may accordingly present a control for merging hierarchies. Further, the electronic device 110 may receive a selection of the control and may merge “Heading B” and “Heading C” into a new hierarchy (e.g., “Body”). As an example, a user may define a hierarchy identifier of the merged hierarchy.

As an example, a plurality of quotations of a paper may be recognized as a plurality of independent hierarchies. However, a single quotation carries less information, and a user may combine a plurality of quotations into a single hierarchy, for example.

In some embodiments, the electronic device 110 may further receive a fourth edit operation from the user to adjust the hierarchical identifier of the at least one hierarchy. For example, the electronic device 110 may support the user modifying the name of each hierarchy.

Based on the above process, embodiments of the present disclosure may support the user further adjusting the automatically recognized hierarchical information to improve the accuracy of the hierarchical information.

In some embodiments, after completing configuration of the hierarchical information, the electronic device 110 may further present a viewing interface 200C as shown in FIG. 2C. In the interface 200C, the electronic device 110 may present a set of indices corresponding to the determined target hierarchical information 255, e.g., “Heading A”, “Heading B”, and “Heading C”, etc.

Additionally, the electronic device 110 may receive a selection of the target index 260 (e.g., heading C) and may accordingly present at least one content portion corresponding to the target index 260, e.g., paragraph 275-1, paragraph 275-2, and paragraph 275-3.

Additionally, the electronic device 110 also supports the user editing a text recognition result of the target content 220 via the viewing interface 200C. For example, the electronic device 110 may click on the paragraph 275-1 for text editing, and may edit the text content in the paragraph 275-1. Additionally, the electronic device 110 may also support the user adding new paragraphs, delete existing paragraphs, adjust the order of the paragraphs, and the like, via the interface 200C.

In some embodiments, the electronic device 110 may further organize the target content into a plurality of knowledge segments (or knowledge slices) based on the determined target hierarchical information.

As an example, each knowledge segment may correspond to the lowest hierarchy in the determined target hierarchical information. Taking FIG. 2C as an example, in a case that the document A includes two hierarchies, a plurality of paragraphs corresponding to the “Heading B” will be organized into a same knowledge segment, and a plurality of paragraphs corresponding to the “Heading C” will be organized into a same knowledge segment.

In some embodiments, the electronic device 110 may further obtain second configuration information, where the second configuration information indicates whether a knowledge segment retains the heading of an associated hierarchy. As an example, the electronic device 110 may also obtain the second configuration information via a configuration control associated with the option 210 as shown in FIG. 2A.

As an example, the configuration control may provide a plurality of preset modes. For example, the preset mode may include a first mode which indicates that the knowledge segment does not retain the heading of the hierarchy. Alternatively, the preset mode may include a second mode which indicates that the knowledge segment retains the heading of the lowest hierarchy. Alternatively, the preset mode may include a third mode which indicates that the knowledge segment retains headings of all associated hierarchies.

Taking FIG. 2C as an example, for the hierarchy “Heading B”, if the second configuration information indicates the first mode, the knowledge segment corresponding to the plurality of paragraphs under “Heading B” will not include the text “Heading B”. If the second configuration information indicates the second mode, the knowledge segment corresponding to the plurality of paragraphs under “Heading B” will only include the text “Heading B”. If the second configuration information indicates the third mode, the knowledge segment corresponding to the plurality of paragraphs under “Heading B” will include the text “Heading A-Heading B”.

Further, after completing organization of the knowledge segments based on the target hierarchical information, the target application may process the received request based on the plurality of organized knowledge segments. As an example, the target application may search for a knowledge segment matching the received request and reference to the knowledge segment to generate corresponding reply content.

FIG. 2D illustrates an example interaction interface 200D of a target application. As shown in FIG. 2D, the target application may receive a query message 280 from the user, and may generate the corresponding response content 285 by querying the knowledge base. As an example, the response content 285 may be generated based on a knowledge segment corresponding to the hierarchy “Heading B”of “Document A”in the knowledge base.

Accordingly, the target application may present, in interface 200D, reference information 290 associated with response content 285 to indicate a hierarchical identifier corresponding to the referenced target knowledge segment, e.g., “Heading B”.

In some embodiments, the electronic device 110 may further display a viewing interface of the target knowledge segment corresponding to the reference information 290 based on the selection of the reference information 290. As an example, the viewing interface may display only the content of the applied target knowledge segment in the knowledge file.

In some embodiments, the electronic device 110 may further display a viewing interface of the target content where the target knowledge segment corresponding to the reference information 290 is located based on the selection of the reference information 290. As an example, the viewing interface may display only the viewing interface of the knowledge file, and may highlight the content of the applied target knowledge segment in the viewing interface.

Based on the above process, the embodiments of the present disclosure can organize the knowledge segments corresponding to the content based on the hierarchical structure of the content, thereby improving the utilization efficiency of the knowledge information.

In some embodiments, the electronic device 110 may further create a corresponding target application based on the knowledge information configuration process mentioned above, for example, an agent, a bot, or other suitable application suitable for calling the knowledge base, such as, a digital assistant.

### EXAMPLE PROCESSES

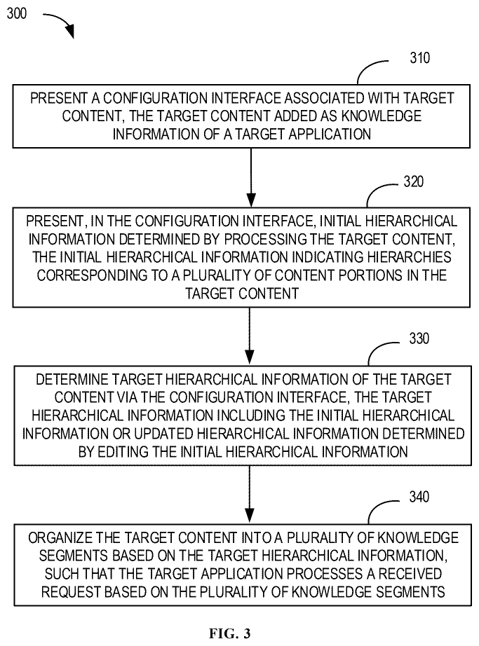

FIG. 3 shows a flowchart of a process 300 for configuring knowledge information according to some embodiments of the present disclosure. The process 300 may be implemented at electronic device 110. The process 300 is described below with reference to FIG. 1.

As shown in FIG. 3, in block 310, the electronic device 110 presents a configuration interface associated with the target content, and the target content is added as knowledge information of a target application.

At block 320, the electronic device 110 presents, in the configuration interface, initial hierarchical information determined by processing the target content, the initial hierarchical information indicating a level corresponding to a plurality of content portions in the target content.

At block 330, the electronic device 110 determines target hierarchical information of the target content via the configuration interface, where the target hierarchical information includes the initial hierarchical information or updated hierarchical information determined by editing the initial hierarchical information.

At block 340, the electronic device 110 organizes the target content into a plurality of knowledge segments based on the target hierarchical information, such that the target application processes the received request based on the plurality of knowledge segments.

In some embodiments, the configuration interface further includes a first region and/or a second region, where a preview result of the target content is displayed in the first region, and a text recognition result of the target content is displayed in the second region.

In some embodiments, the process 300 further includes: in response to a selection of a target hierarchy in the initial hierarchical information, displaying, in the first region and/or the second region, at least one content portion corresponding to the target hierarchy in a target style.

In some embodiments, the process 300 further includes: obtaining first configuration information indicating a maximum number of hierarchies allowed to be segmented; and segmenting the target content based on the first configuration information to determine the initial hierarchical information.

In some embodiments, organizing the target content into a plurality of knowledge segments based on the target hierarchical information includes: obtaining second configuration information indicating whether a knowledge segment retains a heading of an associated hierarchy; and organizing the target content into the plurality of knowledge segments corresponding to the updated hierarchical information based on the second configuration information.

In some embodiments, the second configuration information indicates one of the following: a first mode indicating that the knowledge segment does not retain the heading of the hierarchy; a second mode indicating that the knowledge segment retains a heading of the lowest hierarchy; a third mode indicating that the knowledge segment retains headings of all associated hierarchies.

In some embodiments, determining the target hierarchical information of the target content via the configuration interface includes: receiving at least one edit operation for the initial hierarchical information to determine the updated hierarchical information.

In some embodiments, the at least one edit operation includes: a first edit operation configured to adjust a hierarchy associated with at least one content portion; a second edit operation configured to delete at least one hierarchy in the initial hierarchical information; a third edit operation configured to merge a plurality of hierarchies into a same hierarchy; and a fourth edit operation configured to adjust a hierarchy identifier of at least one hierarchy.

In some embodiments, the process 300 further includes: presenting a viewing interface of the target content, the viewing interface including a set of indices corresponding to the target hierarchical information; and in response to a selection of a target index in the set of indices, displaying at least one content portion corresponding to the target index in the viewing interface.

In some embodiments, the process 300 further includes editing a text recognition result of the at least one content portion via the viewing interface.

In some embodiments, the process 300 further includes: in response to the target application referencing a target knowledge segment in the plurality of knowledge segments, generating response content, triggering to present the response content and reference information associated with the response content in an interaction interface of the target application, the reference information indicating a hierarchy identifier corresponding to the target knowledge segment.

### EXAMPLE APPARATUS AND DEVICE

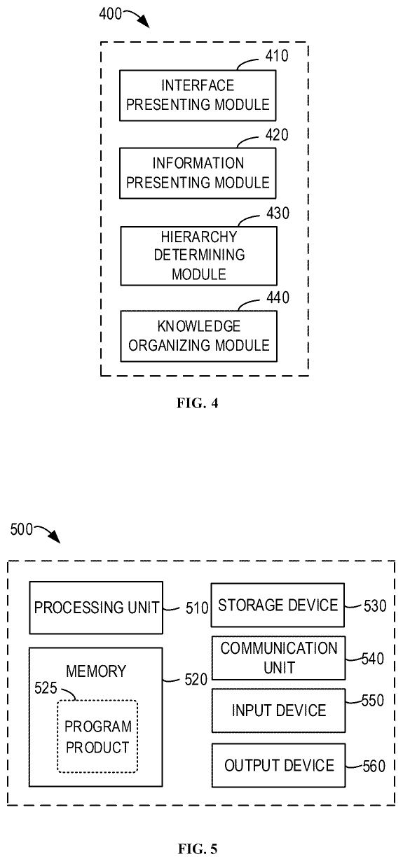

Embodiments of the present disclosure also provide a corresponding apparatus for implementing the above method or process. FIG. 4 is a schematic structural block diagram of an example apparatus 400 for configuring knowledge information according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes: an interface presenting module 410 configured to present a configuration interface associated with the target content, the target content added as knowledge information of a target application; an information presenting module 420 configured to present, in the configuration interface, initial hierarchical information determined by processing the target content, the initial hierarchical information indicating hierarchies corresponding to a plurality of content portions in the target content; a level determining module 430 configured to determine target hierarchical information of the target content via the configuration interface, the target hierarchical information including the initial hierarchical information or updated hierarchical information determined by editing the initial hierarchical information; and a knowledge organizing module 440 configured to organize the target content into a plurality of knowledge segments based on the target hierarchical information, such that the target application processes a received request based on the plurality of knowledge segments. In some embodiments, the configuration interface further includes a first region and/or a second region, wherein a preview result of the target content is displayed in the first region, and a text recognition result of the target content is displayed in the second region.

In some embodiments, the apparatus 400 further includes a selecting module configured to, in response to a selection of a target hierarchy in the initial hierarchical information, displaying, in the first region and/or the second region, at least one content portion corresponding to the target hierarchy in a target style.

In some embodiments, the apparatus 400 further includes a determining module configured to: obtain first configuration information indicating a maximum number of hierarchies allowed to be segmented; and segmenting the target content based on the first configuration information to determine the initial hierarchical information.

In some embodiments, the knowledge organizing module 440 is further configured to: obtain second configuration information indicating whether a knowledge segment retains a heading of an associated hierarchy; and organize the target content into the plurality of knowledge segments corresponding to the updated hierarchical information based on the second configuration information.

In some embodiments, the second configuration information indicates one of the following: a first mode indicating that the knowledge segment does not retain the heading of the hierarchy; a second mode indicating that the knowledge segment retains a heading of the lowest hierarchy; a third mode indicating that the knowledge segment retains headings of all associated hierarchies.

In some embodiments, the hierarchy determination module 430 is further configured to receive at least one edit operation for the initial hierarchical information to determine the updated hierarchical information.

In some embodiments, the at least one edit operation includes: a first edit operation configured to adjust a hierarchy associated with at least one content portion; a second edit operation configured to delete at least one hierarchy in the initial hierarchical information; a third edit operation configured to merge a plurality of hierarchies into a same hierarchy; a fourth edit operation configured to adjust a hierarchy identifier of at least one hierarchy.

In some embodiments, the apparatus 400 further includes an index module configured to: present a viewing interface of the target content, the viewing interface including a set of indices corresponding to the target hierarchical information; and display, in response to a selection of a target index in the set of indices, at least one content portion corresponding to the target index in the viewing interface.

In some embodiments, the apparatus 400 further includes an editing module configured to edit a text recognition result of the at least one content portion via the viewing interface.

In some embodiments, the apparatus 400 further includes a prompting module configured to: in response to the target application referencing a target knowledge segment in the plurality of knowledge segments, generate response content, trigger to present the response content and reference information associated with the response content in an interaction interface of the target application, the reference information indicating a hierarchy identifier corresponding to the target knowledge segment.

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, a plurality of processing units execute computer-executable instructions in parallel to improve parallel processing capabilities of electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to an example implementation of the present disclosure, a computer readable storage medium is provided, on which a computer-executable instruction is stored, where the computer executable instruction is executed by a processor to implement the above-described method. According to an example implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices, and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some updated implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is illustrative, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

What is claimed is:

1. A method for configuring knowledge information, comprising:
presenting a configuration interface associated with target content, the target content added as knowledge information of a target application;
presenting, in the configuration interface, initial hierarchical information determined by processing the target content, the initial hierarchical information indicating hierarchies corresponding to a plurality of content portions in the target content;
determining target hierarchical information of the target content via the configuration interface, the target hierarchical information comprising the initial hierarchical information or updated hierarchical information determined by editing the initial hierarchical information; and
organizing the target content into a plurality of knowledge segments based on the target hierarchical information, such that the target application processes a received request based on the plurality of knowledge segments.

2. The method of claim 1, wherein the configuration interface further comprises at least one of a first region or a second region,
wherein a preview result of the target content is displayed in the first region, and a text recognition result of the target content is displayed in the second region.

3. The method of claim 2, further comprising:
in response to a selection of a target hierarchy in the initial hierarchical information, displaying, in at least one of the first region or the second region, at least one content portion corresponding to the target hierarchy in a target style.

4. The method of claim 1, further comprising:
obtaining first configuration information indicating a maximum number of hierarchies allowed to be segmented; and
segmenting the target content based on the first configuration information to determine the initial hierarchical information.

5. The method of claim 1, wherein organizing the target content into the plurality of knowledge segments based on the target hierarchical information comprises:
obtaining second configuration information indicating whether a knowledge segment retains a heading of an associated hierarchy; and
organizing the target content into the plurality of knowledge segments corresponding to the updated hierarchical information based on the second configuration information.

6. The method of claim 5, wherein the second configuration information indicates one of:
a first mode indicating that the knowledge segment does not retain the heading of the hierarchy;
a second mode indicating that the knowledge segment retains a heading of the lowest hierarchy; or
a third mode indicating that the knowledge segment retains headings of all associated hierarchies.

7. The method of claim 1, wherein determining the target hierarchical information of the target content via the configuration interface comprises:
receiving at least one edit operation for the initial hierarchical information to determine the updated hierarchical information.

8. The method of claim 7, wherein the at least one edit operation comprises:
a first edit operation configured to adjust a hierarchy associated with at least one content portion;
a second edit operation configured to delete at least one hierarchy in the initial hierarchical information;
a third edit operation configured to merge a plurality of hierarchies into a same hierarchy; or
a fourth edit operation configured to adjust a hierarchy identifier of at least one hierarchy.

9. The method of claim 1, further comprising:
presenting a viewing interface of the target content, the viewing interface comprising a set of indices corresponding to the target hierarchical information; and
in response to a selection of a target index in the set of indices, displaying at least one content portion corresponding to the target index in the viewing interface.

10. The method of claim 9, further comprising:
editing a text recognition result of the at least one content portion via the viewing interface.

11. The method of claim 1, further comprising:
in response to the target application referencing a target knowledge segment in the plurality of knowledge segments, generating response content, triggering to present the response content and reference information associated with the response content in an interaction interface of the target application, the reference information indicating a hierarchy identifier corresponding to the target knowledge segment.

12. A method for creating an application, comprising:
configuring knowledge information associated with a target application, wherein the knowledge information indicates a plurality of knowledge segments organized based on target content, wherein the plurality of knowledge segments is determined based on a process comprising:
presenting, in a configuration interface, initial hierarchical information determined by processing the target content, the initial hierarchical information indicating hierarchies corresponding to a plurality of content portions in the target content;
determining target hierarchical information of the target content via the configuration interface, the target hierarchical information comprising the initial hierarchical information or updated hierarchical information determined by editing the initial hierarchical information; and
organizing the target content into a plurality of knowledge segments based on the target hierarchical information; and
creating the target application based on the knowledge information.

13. An electronic device, comprising:
at least one processor; and
at least one memory coupled to the at least one processor and storing instructions for execution by the at least one processor, the instructions, when executed by the at least one processor, causing the electronic device to perform operations comprising:
presenting a configuration interface associated with target content, the target content added as knowledge information of a target application;
presenting, in the configuration interface, initial hierarchical information determined by processing the target content, the initial hierarchical information indicating hierarchies corresponding to a plurality of content portions in the target content;
determining target hierarchical information of the target content via the configuration interface, the target hierarchical information comprising the initial hierarchical information or updated hierarchical information determined by editing the initial hierarchical information; and
organizing the target content into a plurality of knowledge segments based on the target hierarchical information, such that the target application processes a received request based on the plurality of knowledge segments.

14. The electronic device of claim 13, wherein the configuration interface further comprises at least one of a first region or a second region,
wherein a preview result of the target content is displayed in the first region, and a text recognition result of the target content is displayed in the second region.

15. The electronic device of claim 14, wherein the operations further comprise:
in response to a selection of a target hierarchy in the initial hierarchical information, displaying, in at least one of the first region or the second region, at least one content portion corresponding to the target hierarchy in a target style.

16. The electronic device of claim 13, wherein the operations further comprise:
obtaining first configuration information indicating a maximum number of hierarchies allowed to be segmented; and
segmenting the target content based on the first configuration information to determine the initial hierarchical information.

17. The electronic device of claim 13, wherein organizing the target content into the plurality of knowledge segments based on the target hierarchical information comprises:
obtaining second configuration information indicating whether a knowledge segment retains a heading of an associated hierarchy; and
organizing the target content into the plurality of knowledge segments corresponding to the updated hierarchical information based on the second configuration information.

18. The electronic device of claim 17, wherein the second configuration information indicates one of:
a first mode indicating that the knowledge segment does not retain the heading of the hierarchy;
a second mode indicating that the knowledge segment retains a heading of the lowest hierarchy; or
a third mode indicating that the knowledge segment retains headings of all associated hierarchies.
